(19) United States
(12) Patent Application Publication
(10) Pub. No.: US 2009/0313836 A1
(43) Pub. Date: Dec. 24, 2009

(54) SAFETY CUTTER KNIFE

(76) Inventor: SHAO-TSUNG WEI, Taipei City (TW)

Correspondence Address: LEONG C LEI, PMB # 1008, 1867 YGNACIO VALLEY ROAD, WALNUT CREEK, CA, 94598, US

(21) Appl. No.: 12/141,931

(22) Filed: Jun. 19, 2008

(51) Int. Cl. B26B 29/02; B26B 3/06

(52) U.S. Cl. 30/286; 30/162

(57) ABSTRACT

A safety cutter knife includes a cutter blade and a hold down bar arranged in a housing in a parallel manner and respectively slidable in and out of the housing, a spring member mounted in the housing to force the hold down bar out of the housing, a first lock member for locking the hold down bar in the extended position, and a second lock member for locking the hold down bar in the received position.

### BACKGROUND OF THE INVENTION

(a) Technical Field of the Invention

The present invention relates to a cutter knife and more particularly, to a safety cutter knife, which provides a spring-supported hold down bar to avoid finger injury during a cutting operation.

(b) Description of the Prior Art

A cutting knife is an important tool for handcraft working and paper cutting. When using a cutting knife to cut a workpiece, the user will hold the workpiece with one hand and operate the cutting knife with the other hand. When a ruler is used to assist the cutting operation, the user must hold down the ruler with one hand and move the cutting knife along one side of the ruler to cut the workpiece. During cutting, the user's fingers may be injured by cutter blade of the cutting knife accidentally.

### SUMMARY OF THE INVENTION

The primary purpose of the present invention is to provide a safety cutting knife, which avoids accidental finger injury during a cutting operation. According to one aspect of the present invention, the safety cutting knife comprises a housing, a cutter blade mounted with a slide in the housing and movable with the slide in and out of the front open end of the housing, and a hold down bar mounted in the housing in a parallel manner relative to the cutter blade and movable in and out of the front open end of the housing between an extended position and a received position. During a cutting operation, the hold down bar is extended out of the housing and stopped against the workpiece to be cut, and then the cutter blade is forced into the workpiece and moved relative to the workpiece to cut the workpiece as desired. Therefore, the hold down bar prohibits the user's fingers from touching the cutter blade during cutting, avoiding accidental finger injury

According to another aspect of the present invention, the hold down bar has a U-groove longitudinally disposed at one side and facing the cutter blade. When the hold down bar is stopped against the workpiece during cutting, the cutter blade is constrained to the U-groove, avoiding accidental finger injury.

According to still another aspect of the present invention, the safety cutting knife further comprises a spring member mounted inside the housing to impart an outward pressure to the hold down bar, pushing the hold down bar to the extended status.

According to still another aspect of the present invention, the safety cutting knife further comprises first lock means mounted in the housing for locking the hold down bar in the extended position, and second lock means mounted in the housing for locking the hold down bar in the received position.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an elevational view of a safety cutter knife in accordance with the present invention.

FIG. 2 is a perspective view of the present invention, showing the hold down bar moved out of the front end of the housing.

FIG. 3 corresponds to FIG. 2, showing the hold down bar locked in the fully extended position.

FIGS. 4A˜4C illustrate a cutter blade feeding procedure during a cutting operation of the safety cutter knife according to the present invention.

FIGS. 5A˜5C illustrates a cutter blade receiving procedure of the cutting operation of the safety cutter knife according to the present invention.

FIG. 6 is a schematic drawing of the present invention, showing the moving direction of the hold down bar and the angle of inclination of the cutting edge of the cutter blade relative to the hold down bar.

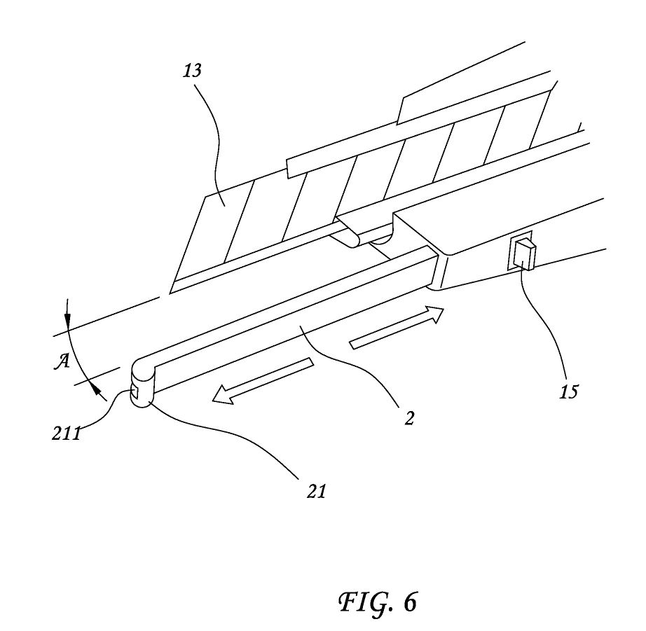

FIG. 7 is a schematic drawing showing a suspended sheet member cutting operation of the present invention.

FIG. 8 is a schematic drawing showing a ruler-assisted cutting operation of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

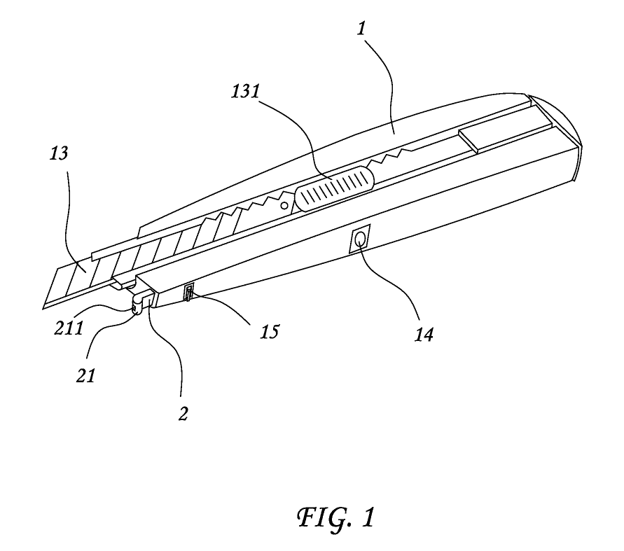

Referring to FIGS. 1˜3 and 6, a safety cutter knife in accordance with the present invention is shown comprising a housing 1. The housing 1 is a hollow elongated member, defining a first sliding groove 11 and a second sliding groove 12. The first sliding groove 11 and the second sliding groove 12 extend along the length of the housing 1 to the front open end of the housing 1. A cutter blade 13 is mounted with a slide 131 in the first sliding groove 11. A person can operate the slide 131 to move the cutter blade 13 in and out of the front end of the first sliding groove 11.

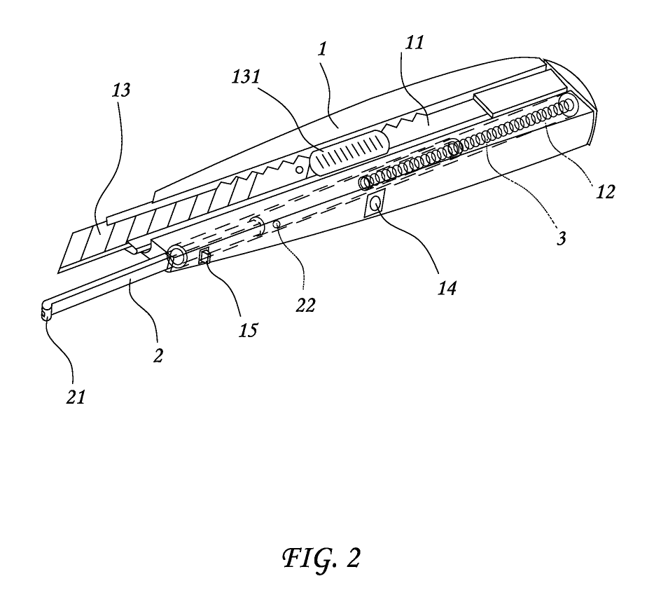

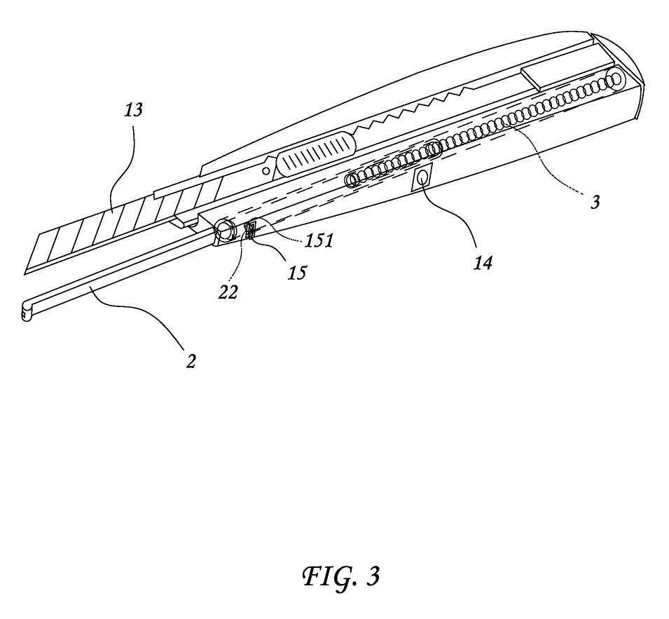

The safety cutter knife further comprises a hold down bar 2 mounted in the second sliding groove 12 and movable in and out of the front open end of the second sliding groove 12. The hold down bar 2 is a flat bar having a front end terminating in an outwardly curved round rod-like tip 21 that suspends outside the front end of the housing 1, a U-groove 211 longitudinally extending on one side thereof and facing the cutter blade 13, and a locating hole 22 on the other side thereof near the rear end. Further, a spring member 3 is mounted inside the second sliding groove 12 and stopped between the rear close end of the housing 1 and the rear end of the hold down bar 2, imparting a pressure to the hold down bar 2 to push the hold down bar 2 out of the second sliding groove 12. In order to selectively lock the hold down bar 2 to the housing 1 in the received position or extended position, a front locking lever 15 and a rear locking switch 14 are respectively mounted on the housing 1 corresponding to the second sliding groove 12 for selectively engaging the locating hole 22. The front locking lever 15 is biasable relative to the housing 1 between a locking position and an unlocking position, provided with a pin 151 for locking the hold down bar 2 in an extended position (see FIG. 2). When the hold down bar 2 is extended out of the second sliding groove 12 to the full extend, the locating hole 22 is aimed at the pin 151 of the front locking lever 15. At this time, the user can operate the front locking lever 15 to engage the pin 151 into the locating hole 22, thereby locking the hold down bar 2 in the fully extended position (see FIG. 3). When biased the front locking lever 15 reversely, the pin 151 is disengaged from the locating hole 22, and therefore the hold down bar 2 is unlocked and slidable in the second sliding groove 12. When the hold down bar 2 is pushed back to the inside of the second sliding groove 12 to the extent, the locating hole 22 is forced into engagement with the rear locking switch 14, and therefore the hold down bar 2 is locked in the received position. When the user pressed the rear locking switch 14 at this time, the hold down bar 2 is unlocked and pushed out of the second sliding groove 12 by the spring member 3.

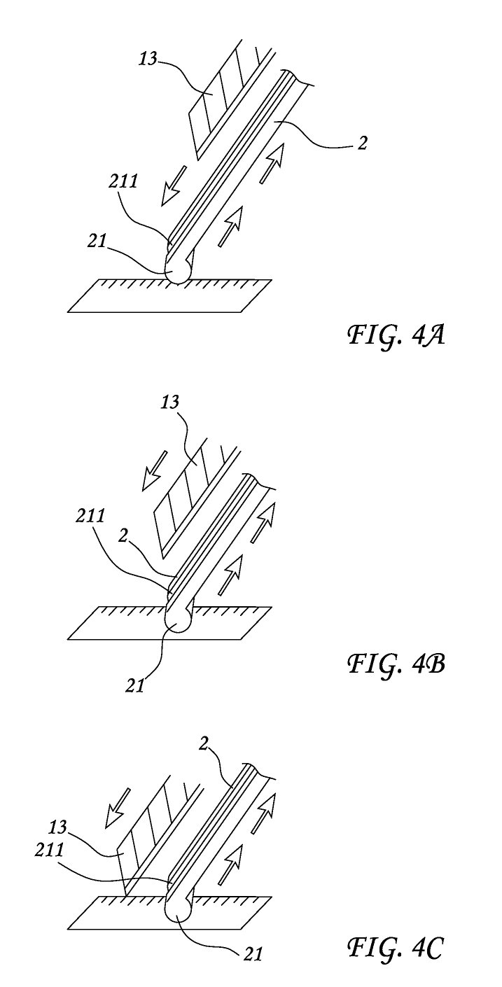

Referring to FIGS. 4A˜4C and FIG. 2 again, when cutting a sheet member with the safety cutter knife, unlock the hold down bar 2 for enabling the hold down bar 2 to be pushed out of the second sliding groove 12, and then stop the outwardly curved round rod-like tip 21 of the hold down bar 2 against the sheet member to be cut while keeping the front locking lever 15 in the unlocked position (see FIG. 4A), and then forcing the housing 1 downwards toward the sheet member (see FIG. 4B) to force the cutting edge of the cutter blade 13 into the sheet member (see FIG. 4C), and then move the housing 1 and the cutter blade 13 relative to the sheet member in the desired direction to cut the sheet member as expected.

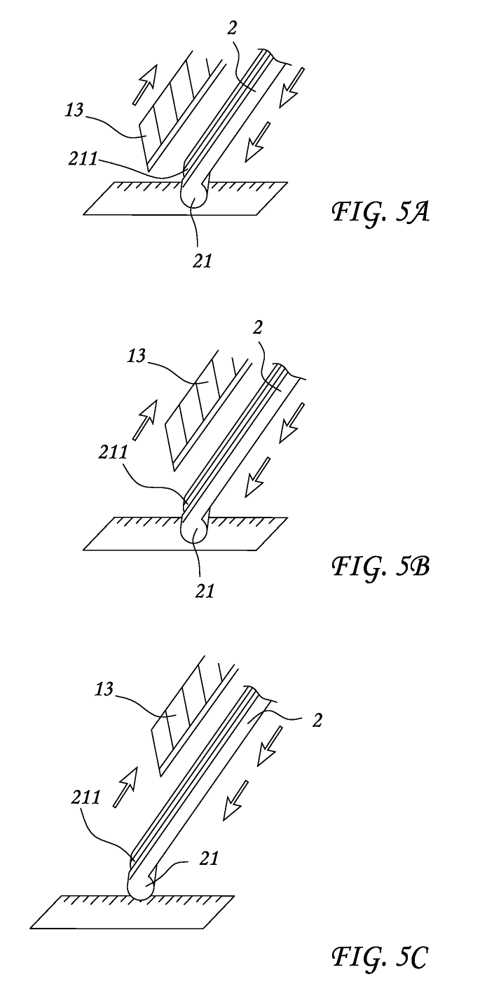

Referring to FIGS. 5A˜5C and FIG. 2 again, after cutting, release the pressure being applied to the housing 1 to have the cutter blade 13 be lifted with the housing 1 relative to the sheet member while the outwardly curved round rod-like tip 21 of the hold down bar 2 is kept stopped against the sheet member (see FIG. 5A). At this time, the spring force of the spring member 3 is applied to the hold down bar 2 against the sheet member, causing the housing 1 and the cutter blade 13 to be moved relative to the hold down bar 2 in direction away from the sheet member (see FIGS. 5B and 5C).

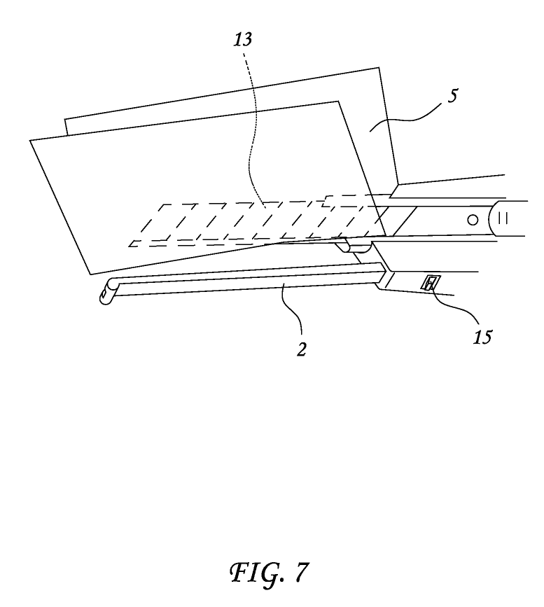

Referring to FIG. 7, when cutting a sheet member 5 in a suspended status, extend out of the hold down bar 2 and operate the front locking lever 15 to lock the hold down bar 2 in the fully extended position, and then insert the sheet member 5 into the gap between the cutter blade 13 and the hold down bar 2, and then use the cutter blade 13 to cut the sheet member 15 as desired. The cutting edge of the cutter blade 13 shows an angle of inclination A relative to the hold down bar 2. Preferably, this angle of inclination A is within 5°˜10°.

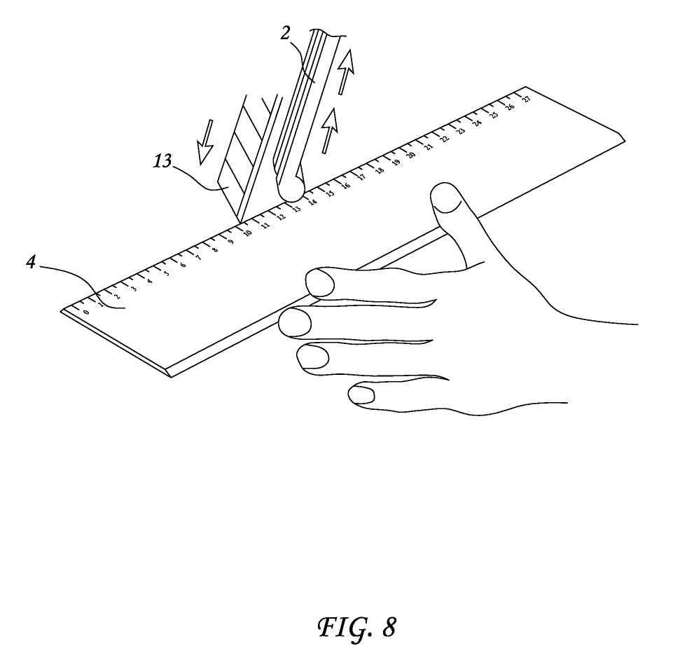

Referring to FIG. 8, when cutting a sheet member under the assist of a ruler 4, stop the outwardly curved round rod-like tip 21 of the hold down bar 2 at the ruler 4 against the sheet member, and then force the cutting edge of the cutter blade 13 into the sheet member and move the cutter blade 13 along one side of the ruler 4 to cut the sheet member as expected.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A safety cutter knife, comprising:
a housing, said housing comprising a first sliding groove and a second sliding respectively linearly extending along a length of said housing to a front open end of said housing;
a cutter blade mounted with a slide in said first sliding groove of said housing and movable with said slide in and out of the front open end of said housing;
a hold down bar mounted in said second sliding groove of said housing and movable in and out of the front open end of said housing between an extended position and a received position;
spring means mounted inside said housing and adapted for imparting an outward pressure to said hold down bar to push said hold down bar out of the front open end of said housing from said received position to said extended position;
first lock means mounted in said housing and adapted for locking said hold down bar in said extended position; and
second lock means mounted in said housing and adapted for locking said hold down bar in said received position.

2. The safety cutter knife as claimed in claim 1, wherein said hold down bar is a flat bar having a front end terminating in an outwardly curved round rod-like tip and a U-groove longitudinally extending on one side thereof and facing said cutter blade.

3. The safety cutter knife as claimed in claim 1, wherein said hold down bar comprises a locating hole disposed near a rear end thereof; said first lock means comprises a locking lever pivoted to said housing corresponding to said second sliding groove near the front open end of said housing, and a pin movable by said locking lever for engaging the locating hole of said hold down bar.

4. The safety cutter knife as claimed in claim 1, wherein said cutter blade has a cutting edge sloping in one direction at an angle of inclination about 5°˜10°.
